(19) United States
(12) Patent Application Publication
(10) Pub. No.: US 2011/0064251 A1
(43) Pub. Date: Mar. 17, 2011

(54) SPEAKER AND VIBRATOR ASSEMBLY FOR AN ELECTRONIC DEVICE

(76) Inventor: Georg Siotis, Lund (SE)

(21) Appl. No.: 12/557,789

(22) Filed: Sep. 11, 2009

(51) Int. Cl. H04R 1/00

(52) U.S. Cl. 381/191

(57) ABSTRACT

Vibration generation for an electronic device is performed by a speaker and vibrator assembly. In an audio mode, the assembly may be used to output audio, such as ringtones, alerts, music, and so forth. In a vibration mode, speakers of the assembly drive movement of a weight. The movement of the weight results in user-detectable vibration of the electronic device. Also, audio and vibration may be output at the same time by using a signal that includes an audio component and a signal that results in movement of the weight.

### TECHNICAL FIELD OF THE INVENTION

The technology of the present disclosure relates generally to portable electronic devices and, more particularly, to a combined speaker and vibrator assembly for an electronic device.

### BACKGROUND

Portable electronic devices, such as mobile telephones and media players, have been increasing in popularity. Many portable electronic devices are configured to perform a wide variety of functions. For example, a mobile telephone may make and receive telephone calls, send and receive messages, take photographs, browse the Internet, play audiovisual content (e.g., music files and video files), and play games, to name a few functions.

Mobile telephones may output a variety of alerts to a user. An example of an alert is a ringtone that is played when the mobile telephone receives a telephone call. For a multifunction device, there may be a variety of alerts. For example, a mobile telephone may have different tones to alert a user to each of a telephone call, a missed call, a text message, a picture message, and so on.

In some situations, a user may not desire an audible alert or may not be able to hear an audible alert. Therefore, many mobile telephones have a vibration feature in which the alert is a relatively inaudible physical vibration. When set to vibration mode, vibration of the electronic device may be felt by the user. Vibration may be used in other circumstances, such as to provide input confirmation in the form of haptic feedback when a user interacts with an input device or as part of a user interface with a game.

Conventional vibrator assemblies include an electric motor that drives an eccentrically mounted weight to produce vibration. This type of vibrator assembly may cause interference with communications activity of the electronic device, may consume a relatively large amount of power, may consume a relatively large amount of space within a housing of the electronic device, and may reduce the reliability of the electronic device because of drawbacks related to wear cycle and drop force sensitivity of the motor assembly.

### SUMMARY

Embodiments of the present disclosure are directed to a vibration generator that does not employ an electric motor. Rather, vibration generation is performed by a speaker and vibrator assembly. In an audio mode, the assembly may be used to output audio, such as ringtones, audible alerts, music, and so forth. In a vibration mode, speakers of the assembly may drive movement of a weight. Also, audio and vibration may be output at the same time by using a signal that includes an audio component and a signal that results in movement of the weight. The movement of the weight results in user-detectable vibration of the electronic device. In comparison to motor generated vibration, vibration generated with the disclosed assembly has less “rumbling” and is commensurately quieter and more pleasant to the user.

According to one aspect of the disclosure, a speaker and vibration assembly for an electronic device includes a housing; a first speaker mounted with respect to the housing; a second speaker mounted with respect to the housing in opposing fashion to the first speaker; and a weight suspended between the speaker and in the housing.

According to one embodiment of the speaker and vibration assembly, the assembly is substantially air tight.

According to one embodiment of the speaker and vibration assembly, the speakers are mounted to seal respective apertures in first and second sides of the housing.

According to one embodiment of the speaker and vibration assembly, the speakers include electro-dynamic membranes.

According to one embodiment of the speaker and vibration assembly, the weight is mounted to a membrane that cooperates with the housing to divide an internal volume of the housing into two cavities.

According to one embodiment of the speaker and vibration assembly, the membrane seals an aperture in a separator wall of the housing.

According to one embodiment of the speaker and vibration assembly, the cavities have about the same volume.

According to one embodiment of the speaker and vibration assembly, the membrane is an electro-dynamic speaker membrane.

According to one embodiment of the speaker and vibration assembly, a center frequency of a resonant system formed by the membrane and the weight is in the range of about 100 Hz to about 200 Hz.

According to one embodiment of the speaker and vibration assembly, a first signal is applied to the first speaker and a second signal with opposite phase to the first signal is applied to the second speaker to achieve oscillation of the weight that results in vibration of the electronic device.

According to one embodiment of the speaker and vibration assembly, a frequency of the first and second signals is matched to a resonant frequency of a resonant system formed by the weight and a membrane by which the weight is suspended.

According to one embodiment of the speaker and vibration assembly, a frequency of the first and second signals is about 150 Hz.

According to one embodiment of the speaker and vibration assembly, audio is output from the speaker and vibration assembly by applying audio signals to the speakers, the audio signals being in-phase.

According to one embodiment of the speaker and vibration assembly, for a mono audio output, the audio signal applied to each speaker is the same.

According to one embodiment of the speaker and vibration assembly, for a stereo audio output, the audio signal applied to one of the speakers is a right channel audio signal and the audio signal applied to the other of the speakers is a left channel audio signal.

According to one embodiment of the speaker and vibration assembly, audio and vibration are simultaneously output from the speaker and vibration assembly by applying a first signal to the first speaker and a second signal to the second speaker, the first signal including a vibration inducing component and an audio signal component, and the second signal including a vibration inducing component in opposite phase to the vibration inducing component of the first signal and an audio signal component.

According to another aspect of the disclosure, an electronic device includes a communications circuit for engaging in wireless communications over a network; a speaker and vibration assembly including a housing, a first speaker mounted with respect to the housing, a second speaker mounted with respect to the housing in opposing fashion to the first speaker, and a weight suspended between the speaker and in the housing; and a controller that controls the application of signals to the speakers such that the speaker and vibration assembly outputs audio in an audio output mode and such that the speaker and vibration assembly moves the weight so as to vibrate the electronic device in a vibration mode to alert a user to a communication event involving the communications circuit.

According to one embodiment of the electronic device, the weight is mounted to a membrane that cooperates with the housing to divide an internal volume of the housing into two cavities.

According to one embodiment of the electronic device, the signals applied in the vibration mode include a first signal that is applied to the first speaker and a second signal with opposite phase to the first signal that is applied to the second speaker to achieve oscillation of the weight.

According to one embodiment of the electronic device, a frequency of the first and second signals is matched to a resonant frequency of a resonant system formed by the weight and a membrane by which the weight is suspended.

According to one embodiment of the electronic device, the signals applied in the audio output mode are in-phase audio signals.

According to one embodiment of the electronic device, audio and vibration are simultaneously output from the speaker and vibration assembly by applying a first signal to the first speaker and a second signal to the second speaker, the first signal including a vibration inducing component and an audio signal component, and the second signal including a vibration inducing component in opposite phase to the vibration inducing component of the first signal and an audio signal component.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic block diagram of an electronic device that forms part of a communications system; and

FIG. 2 is a cross-section of a speaker and vibration assembly for the electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a portable radio communications device, such as the illustrated mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a game controller, an electronic toy, a computer (including desktop computers or accessories, laptop computers or accessories, and other form factors, such as scaled-down laptops geared toward Internet browsing that are commonly referred to as net-books or surf-pads), a pager, a communicator, an electronic organizer, a personal digital assistant (PDA), etc.

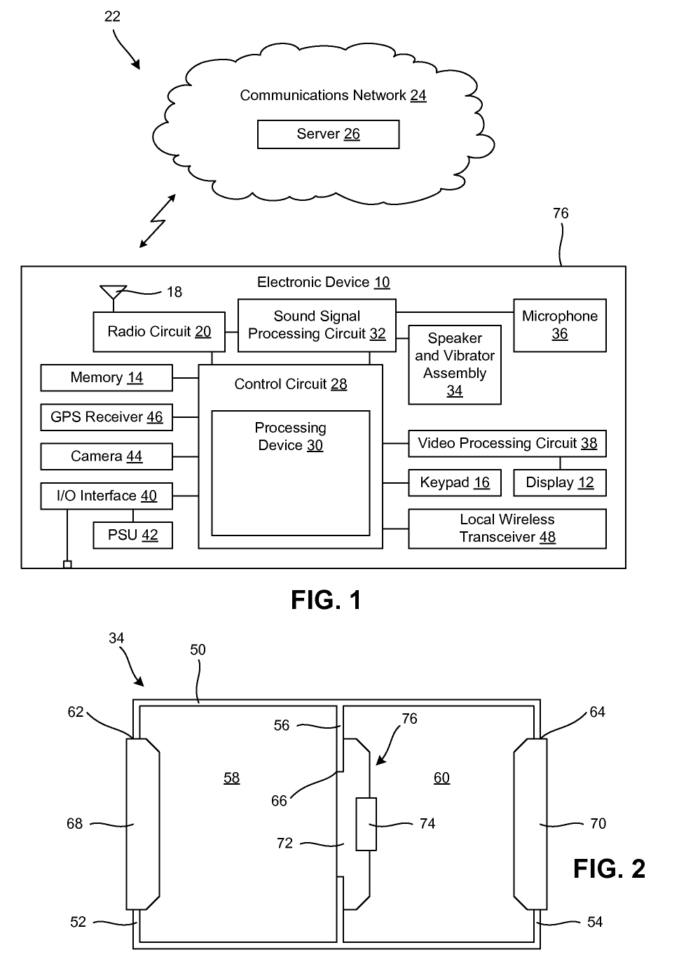

Referring initially to FIG. 1, an electronic device 10 in the representative form of a mobile phone (also referred to as a “smart-phone”) is shown. The electronic device 10 may include a display 12. The display 12 displays information to a user such as operating state, time, telephone numbers, contact information, various menus, etc., that enable the user to utilize the various features of the electronic device 10. The display 12 also may be used to visually display content received by the electronic device 10 and/or retrieved from a memory 14 of the electronic device 10. Therefore, the display 12 may be used to present images, video and other graphics to the user, such as the content of messages, photographs, video, Internet pages, and so forth.

A keypad 16 provides for a variety of user input operations. For example, the keypad 16 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. In addition to the keypad 16 or instead of the keypad 16, input functionality may be embodied using touch screen technology that is associated with the display 12. Also, the display 12 and keypad 16 may be used in conjunction with one another to implement soft key functionality.

The electronic device 10 includes communications circuitry that enables the electronic device 10 to establish communications with another device. Communications may include calls, data transfers, and the like. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFi, or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the electronic device 10, including storing the data in the memory 14, executing applications to allow user interaction with the data, displaying video and/or image content associated with the data, outputting audio sounds associated with the data, and so forth.

In the illustrated exemplary embodiment, the communications circuitry may include an antenna 18 coupled to a radio circuit 20. The radio circuit 20 includes a radio frequency transmitter and receiver for transmitting and receiving signals via the antenna 18. The radio circuit 20 may be configured to operate in a mobile communications system 22. Radio circuit 20 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 18 and the radio circuit 20 may represent one or more than one radio transceiver.

The system 22 may include a communications network 24 having a server 26 (or servers) for managing calls placed by and destined to the electronic device 10, transmitting data to and receiving data from the electronic device 10 and carrying out any other support functions. The network 24 communicates with the electronic device 10 via a transmission medium. The transmission medium may be any appropriate device or assembly, including, for example, a communications base station (e.g., a cellular service tower, or “cell” tower), a wireless access point, a satellite, etc. The network 24 may support the communications activity of multiple electronic devices 10 and other types of end user devices. As will be appreciated, the server 26 may be configured as a typical computer system used to carry out server functions and may include a processor configured to execute software containing logical instructions that embody the functions of the server 26 and a memory to store such software.

The electronic device 10 may include a primary control circuit 28 that is configured to carry out overall control of the electronic device, including the functions described in this document. The control circuit 28 may include a processing device 30, such as a central processing unit (CPU), microcontroller or microprocessor. To effectuate the functions of the electronic device, the processing device 30 executes code stored in a memory (not shown) within the control circuit 28 and/or in a separate memory, such as the memory 14. For instance, the memory 14 may store executable code that embodies the operations of the electronic device 10 and the processing device 30 may execute that code. The memory 14 may be, for example, one or more of a buffer, a flash memory, a hard drive, a removable media, a volatile memory, a non-volatile memory, a random access memory (RAM), or other suitable device. In a typical arrangement, the memory 14 may include a non-volatile memory for long term data storage and a volatile memory that functions as system memory for the control circuit 28. The memory 14 may exchange data with the control circuit 28 over a data bus. Accompanying control lines and an address bus between the memory 14 and the control circuit 28 also may be present.

The electronic device 10 further includes a sound signal processing circuit 32 for handling audio signals. Audio signals handled by the sound signal processing circuit include, for example, signals that are transmitted by and received from the radio circuit 20 as part of calls. Other audio signals that are handled by the sound signal processing circuit 32 may include signals that are associated with the various operations of the electronic device 10, such as audio content playback, audible alert generation, and vibrator operation.

Coupled to the sound processing circuit 32 are a speaker and vibrator assembly 34 and a microphone 36 that respectively enable a user to listen and speak via the electronic device 10. The radio circuit 20 and sound processing circuit 32 are each coupled to the control circuit 28 so as to carry out overall operation. Audio data may be passed from the control circuit 28 to the sound signal processing circuit 32 for playback to the user. The audio data may include, for example, audio data from an audio file stored by the memory 14 and retrieved by the control circuit 28, or received audio data such as in the form of voice communications or streaming audio data from a mobile radio service. The audio data also may be in the form of a signal to activate vibration of the electronic device 10 as described in greater detail below. The sound signal processing circuit 32 may include any appropriate buffers, decoders, encoders, amplifiers, and so forth.

The display 12 may be coupled to the control circuit 28 by a video processing circuit 38 that converts video data to a video signal used to drive the display 12. The video processing circuit 38 may include any appropriate buffers, decoders, video data processors, and so forth. The video data may be generated by the control circuit 28, retrieved from a video file that is stored in the memory 14, derived from an incoming video data stream that is received by the radio circuit 20, or obtained by any other suitable method.

The electronic device 10 may further include one or more input/output (I/O) interface(s) 40. The I/O interface(s) 40 may be in the form of typical mobile telephone I/O interfaces and may include one or more electrical connectors. The I/O interfaces 40 may form one or more data ports for connecting the electronic device 10 to another device (e.g., a computer) or an accessory (e.g., a personal hands-free (PHF) device) via a cable. Further, operating power may be received over the I/O interface(s) 40 and power to charge a battery of a power supply unit (PSU) 42 within the electronic device 10 may be received over the I/O interface(s) 40. The PSU 42 may supply power to operate the electronic device 10 in the absence of an external power source.

The electronic device 10 also may include various other components. For instance, a camera 44 may be present for taking digital pictures and/or movies. Image and/or video files corresponding to the pictures and/or movies may be stored in the memory 14. A position data receiver, such as a global positioning system (GPS) receiver 46, may be involved in determining the location of the electronic device 10. A local transceiver 48, such as an infrared transceiver and/or an RF transceiver (e.g., a Bluetooth chipset) may be used to establish communication with a nearby device, such as a wireless accessory (e.g., a PHF device), another mobile radio terminal, a computer or another device.

With additional reference to FIG. 2, the speaker and vibrator assembly 34 is illustrated in greater detail. The assembly 34 includes a housing 50. In one embodiment, the housing 50 is a hollow box that has a first end wall 52 spaced apart from a second end wall 54. The end walls 52 and 54 may be arranged to be generally parallel with respect to each other. A separator wall 56 may be disposed in the housing 50 and between the end walls 52 and 54. In one embodiment, the separator wall 56 is arranged to be generally parallel to the walls 52 and 54, and a distance between the first end wall 52 and the separator wall 56 may be about the same as a distance between the second end wall 54 and the separator wall 56. Together with a top wall, a bottom, a front wall (not shown) and a rear wall of the housing 50, the end walls 52 and 54 and the separator wall 56 form a first cavity 58 and a second cavity 60. The first and second cavities 58 and 60 may have the same or approximately the same volumes. The housing 50, including the separator wall 56, may be made from a relatively rigid material, such as plastic or metal, so as to have minimal deformation when subjected to vibration generated by the assembly 34.

Each of the first end wall 52, the second end wall 54 and the separator wall 56 may have an aperture, respectively labeled 62, 64 and 66 in FIG. 2. A first speaker 68 may be mounted in the aperture 62 of the first end wall 52. Alternatively, the first speaker 68 may be mounted to the first end wall 52 to cover the aperture 62. In this embodiment, the aperture 62 in the first end wall 52 may be made up of plural individual holes. The first speaker 62 may interface with the housing 50 so as to seal the aperture 62. Adhesive, foam, or other material may be used to assist in forming the seal. The seal may prevent or minimize air flow through the aperture 62 so that no or very little air is exchanged between the environment external the assembly 34 and the first cavity 58.

Similarly, a second speaker 70 may be mounted in the aperture 64 of the second end wall 54. Alternatively, the second speaker 70 may be mounted to the second end wall 54 to cover the aperture 64. In this embodiment, the aperture 64 in the second end wall 54 may be made up of plural individual holes. The second speaker 64 may interface with the housing 50 so as to seal the aperture 64. Adhesive, foam, or other material may be used to assist in forming the seal. The seal may prevent or minimize air flow through the aperture 64 so that no or very little air is exchanged between the environment external the assembly 34 and the second cavity 60.

The first and second speakers 68 and 70 may each include an electro-dynamic member (e.g., a speaker cone), a voice coil and corresponding permanent magnet. The voice coil may be operatively connected to the sound signal processing circuit 32 so that audio signals from the sound processing circuit 32 may be converted to audible sound waves by the speakers 68 and 70. The speakers 68 and 70 may be mounted in opposing fashion. For instance, the electro-dynamic members of each speaker 68 and 70 each may face outward from the assembly 34 so as to point in opposite directions.

A slave membrane 72 may be mounted to the separator wall 56 to cover the aperture 66 in the separator wall 56. In another embodiment, the aperture 66 may be made from plural holes, each of which is covered by the slave membrane 72. The slave membrane 72 may interface with the housing 50 (e.g., the separator wall 56) so as to seal the aperture 66. Adhesive, foam, or other material may be used to assist in forming the seal. The seal may prevent of minimize air flow through the aperture 66 so that no or very little air is exchanged between the first cavity 58 and the second cavity 60.

In one embodiment, the slave membrane 72 may be made from an electro-dynamic member (e.g., a speaker cone). A weight 74 may be mounted to the slave membrane 72. Together, the slave membrane 72 and the weight 74 (also referred to as a counterweight) may be considered a slave membrane assembly 76. The weight may be made from plastic or metal. A voice coil and permanent magnet may not form part of the slave membrane assembly 76. The slave membrane assembly 76 may be configured to form a resonant system. In one embodiment, a center frequency of the resonant system may be in the range of about 100 Hz to about 200 Hz, and, in one embodiment, a center frequency of the resonant system the may be about 150 hertz (Hz), which is the frequency of many conventional motor-driven vibrators. A resonance (Q) of the slave membrane assembly 76 may be selected to be relatively high. For example, if the center frequency is about 150 Hz, with a delta frequency of 10 Hz (or a resonant frequency range of 140 Hz to 160 Hz), Q will be about 7.5. Other exemplary resonance values may be about 3 to about 4. It will be appreciated that the center frequency and Q will depend on the components that are used to make up the resonant system. In other embodiments, the slave membrane may be a flexible sheath that covers the aperture 66 and suspends the weight 74 in or near the aperture 66.

When one or both of the speakers 68 and/or 70 are driven with an audio signal, they may move and transfer force to the air in the cavities 58 and/or 60. As a result, air pressure may develop in the corresponding cavity 58 and/or 60. This air pressure may apply force to the slave member 72 that causes the slave membrane 72 to move in response. Movement of the slave membrane 72 also results in movement of the connected weight 74. If enough movement of the slave membrane 72 is caused to result in a vibratory effect on the weight 74, the vibration force will be transferred to the housing 50. The housing 50 may be securely mounted in the electronic device 10. For instance, the housing 50 may be secured to a printed circuit board that retains electronic components of the electronic device 10. Alternatively, the housing 50 may be retained by or integrally formed with a housing 76 (FIG. 1) of the electronic device 10. Therefore, vibration of the housing 50 may be transferred to the electronic device 10 and such vibration may be detected by a user, especially if the electronic device 10 is held, is in a pocket of the user's clothing, or is clipped onto the user's clothing.

When the speaker and vibrator assembly 34 is used to output audio to a user (e.g., music or the speech of a remote person during a voice communication), the speakers 68 and 70 may be operated in phase. In this manner, movement of the slave membrane 72 caused by movement of the speakers 68 and 70 to generate the audio output may be minimized. For example, for outputting a mono audio signal, the same audio signal may be applied to each speaker 68 and 70. The speakers 68 and 70 will move in phase with one another so that the differential pressure in the middle of the assembly 34 at the slave membrane 72 will be relatively small or even zero. As a result, vibration generating movement of the weight 74 will not result because of generating audible sounds from a mono audio signal.

For outputting a stereo audio signal, a left channel audio signal may be applied to one of the speakers 68 or 70 and a right channel audio signal may be applied to the other of the speakers 68 or 70. The differential pressure at the slave membrane 72 will have a correlation to any difference between the left channel audio signal and the right channel audio signal. For low frequencies, the differential pressure is likely to be small or zero. For high frequencies, there may be some differential pressure, but it is contemplated that the differential pressure will be negligible enough to not result in significant movement of the slave membrane 72 and weight 74 that generates detectable vibration to the user.

To achieve vibration of the electronic device 10, an audio signal may be applied to one or both of the speakers 68 and 70 in a manner to achieve a pressure differential at the slave membrane 72 so that the weight 74 moves in a manner to transfer vibration energy to the body 76, thereby producing vibration of the electronic device 10. In one embodiment, a sinusoidal (also referred to as sinus) signal is applied to both speakers 68 and 70, where the signal applied to the speaker 68 has an opposite phase to the signal applied to the speaker 70. In this manner, maximal excursion of the slave membrane 72 and weight 74 may be achieved by creating an oscillating pressure differential at the slave membrane 72. The signal applied to each speaker 68 and 70 may be, for example, a sinusoidal signal with a frequency in the range of about 100 Hz to about 200 Hz and relatively high amplitude, such as about −6 dBV (0.5 V RMS) to about 12 dBV (4 V RMS). In a more specific embodiment, the signal applied to each speaker 68 and 70 may have a frequency of about 150 Hz signal with an amplitude of about −3 dBV (0.707 V RMS) to about 9 dBV (2.82 V RMS). For purposes of this description, it will be assumed that 0 dBV equals 1 V RMS. It will be appreciated that the frequency and amplitude of the signals may depend on the sensitivity of the speakers, the volume of the cavities, the weight and resonance frequency of the resonance system, and other factors.

In one embodiment, simultaneous audio output and vibration generation may be accomplished. In this embodiment, one or both of the signals to achieve vibration (e.g., the above-described signals that are 180 degrees out of phase) may be mixed with an audio signal. This approach may be used to output an audible ring tone and to vibrate the electronic device at the same time, for example.

The vibration may be produced to alert the user to an event, such as an incoming call, an incoming message, completion of a download, arrival of a calendar event, and so forth. The vibration may be used by itself as an alert or in combination with an audible alert. For example, the vibration may follow or precede the playback of a ring tone, chime or other sound. The vibration may be controlled to have a predetermined duration. Also, the vibration may be controlled to have a predetermined pattern and/or to repeat. For example, vibration may be turned on and off every half second for an incoming call from a known caller (e.g., a period of one second with a 50 percent duty cycle) and, for an incoming call for an unknown caller, the vibration may have a period of two seconds with a duty cycle of 25 percent.

It will be appreciated that vibration may be generated in circumstances other than to alert the user to an event. For instance, vibration output may be used as part of a gaming experience. In another example, vibration output may be used as haptic feedback to confirm user interaction with a keypad, touch screen or other user input device.

Although certain embodiments have been shown and described, it is understood that equivalents and modifications falling within the scope of the appended claims will occur to others who are skilled in the art upon the reading and understanding of this specification.

1. A speaker and vibration assembly for an electronic device, comprising:
a housing;
a first speaker mounted with respect to the housing;
a second speaker mounted with respect to the housing in opposing fashion to the first speaker; and
a weight suspended between the speaker and in the housing.

2. (canceled)

3. The speaker and vibration assembly of claim 1, wherein the speakers are mounted to seal respective apertures in first and second sides of the housing.

4. (canceled)

5. The speaker and vibration assembly of claim 1, wherein the weight is mounted to a membrane that cooperates with the housing to divide an internal volume of the housing into two cavities.

6. The speaker and vibration assembly of claim 5, wherein the membrane seals an aperture in a separator wall of the housing.

7. The speaker and vibration assembly of claim 5, wherein the cavities have about the same volume.

8. The speaker and vibration assembly of claim 5, wherein the membrane is an electro-dynamic speaker membrane.

9. The speaker and vibration assembly of claim 5, wherein a center frequency of a resonant system formed by the membrane and the weight is in the range of about 100 Hz to about 200 Hz.

10. The speaker and vibration assembly of claim 1, wherein a first signal is applied to the first speaker and a second signal with opposite phase to the first signal is applied to the second speaker to achieve oscillation of the weight that results in vibration of the electronic device.

11. The speaker and vibration assembly of claim 10, wherein a frequency of the first and second signals is matched to a resonant frequency of a resonant system formed by the weight and a membrane by which the weight is suspended.

12. The speaker and vibration assembly of claim 10, wherein a frequency of the first and second signals is about 150 Hz.

13. The speaker and vibration assembly of claim 1, wherein audio is output from the speaker and vibration assembly by applying audio signals to the speakers, the audio signals being in-phase.

14. The speaker and vibration assembly of claim 13, wherein for a mono audio output, the audio signal applied to each speaker is the same.

15. The speaker and vibration assembly of claim 13, wherein for a stereo audio output, the audio signal applied to one of the speakers is a right channel audio signal and the audio signal applied to the other of the speakers is a left channel audio signal.

16. The speaker and vibration assembly of claim 1, wherein audio and vibration are simultaneously output from the speaker and vibration assembly by applying a first signal to the first speaker and a second signal to the second speaker, the first signal including a vibration inducing component and an audio signal component, and the second signal including a vibration inducing component in opposite phase to the vibration inducing component of the first signal and an audio signal component.

17. An electronic device, comprising:
a communications circuit for engaging in wireless communications over a network;
a speaker and vibration assembly including:
a housing;
a first speaker mounted with respect to the housing;
a second speaker mounted with respect to the housing in opposing fashion to the first speaker; and
a weight suspended between the speaker and in the housing; and
a controller that controls the application of signals to the speakers such that the speaker and vibration assembly outputs audio in an audio output mode and such that the speaker and vibration assembly moves the weight so as to vibrate the electronic device in a vibration mode to alert a user to a communication event involving the communications circuit.

18. The electronic device of claim 17, wherein the weight is mounted to a membrane that cooperates with the housing to divide an internal volume of the housing into two cavities.

19. The electronic device of claim 17, wherein the signals applied in the vibration mode include a first signal that is applied to the first speaker and a second signal with opposite phase to the first signal that is applied to the second speaker to achieve oscillation of the weight.

20. The electronic device of claim 19, wherein a frequency of the first and second signals is matched to a resonant frequency of a resonant system formed by the weight and a membrane by which the weight is suspended.

21. The electronic device of claim 17, wherein the signals applied in the audio output mode are in-phase audio signals.

22. The electronic device of claim 17, wherein audio and vibration are simultaneously output from the speaker and vibration assembly by applying a first signal to the first speaker and a second signal to the second speaker, the first signal including a vibration inducing component and an audio signal component, and the second signal including a vibration inducing component in opposite phase to the vibration inducing component of the first signal and an audio signal component.
